(19) United States
(12) Patent Application Publication
(10) Pub. No.: US 2008/0230151 A1
(43) Pub. Date: Sep. 25, 2008

(54) Board Edger

(76) Inventors: Ken Appeldoorn, Statesboro, GA (US); James D. Woodford, New Brunswick (CA); Hugh Hawley, New Brunswick (CA); Stephen Mockler, New Brunswick (CA)

Correspondence Address: Anderson Gorecki & Manaras LLP, 33 NAGOG PARK, ACTON, MA, 01720, US

(21) Appl. No.: 11/688,428

(22) Filed: Mar. 20, 2007

(51) Int. Cl. B23Q 15/00

(52) U.S. Cl. 144/382

(57) ABSTRACT

A board edger is taught that includes an infeed conveyor, a scanner for scanning a board to be edged as it passes on the infeed conveyor to determine orientation and dimension and a saw. The saw includes a reference plane for supporting a board to be edged, a first saw box disposed adjacent the reference plane and having at least two blades controllable for width, longitudinal angle and depth, a second saw box disposed adjacent the reference plane and having at least two blades controllable for width, longitudinal angle and depth, and a saw controller coupled to the scanner for receiving signals from the scanner and coupled to the first and second saw boxes for setting the first saw box for cutting and controlling the cutting by the second saw box. Advantageously, while one saw box is cutting a board the other saw box is being set up by the saw controller to cut the next board thereby decreasing the spacing required between boards. This increases the throughout of the board edger.

### FIELD OF THE INVENTION

The present invention relates to board edgers and is particularly concerned with edgers capable of handling misaligned boards.

### BACKGROUND OF THE INVENTION

The efficient production for saleable lumber from sawn boards is critical to saw mill viability. One way to improve efficiency is to increase production rates. In order to achieve increased production and efficiency many improvements have been made in equipment. One such improvement is taught in the applicant's U.S. Pat. No. 6,929,043, an optimized board edger in which the structure of the saw blade moving mechanism has a low inertia, for rapid positioning of the saw blades. The cutting tool in the optimized board edger follows optimized cut lines on a virtual entity of the wood board to be trimmed. This virtual entity is made to be longer than the wood board such that the tracking of the optimized cut lines starts before the saw blades enter the leading edge of the wood board and ends after the saw blades have completely exited the wood board. This patent addresses efficiency by ensuring that lumber is efficiently sawn from boards received regardless of misalignment of the boards relative to the axis of the infeed conveyor. While avoiding the problem of skewed cut lines, the board edger does require a gap between boards, corresponding to the extension beyond the actual board needed to start the saw box moving in the desired direction and at the desired angle to optimize usable lumber production and set up time for the saw blades to reach the initial position.

Hence, despite such improvements in board edging a problem still remains that affects the board throughput rate and hence the sawmill's production rate. The throughput is dependent upon several factors, the length of the board, the belt speed, the scanner/optimizer/controller processing time and the machine preset time. Regardless of the type of board edger used, it is necessary to provide a gap between boards. The size of this gap relative to the length of the boards being sawn, prevents the mill operator from optimizing the efficiency of the mill's operation.

### SUMMARY OF THE INVENTION

An object of the present invention is to provide an improved board edger.

In accordance with an aspect of the present invention there is provided a A board edger comprising an input for receiving a signal from a scanner, a reference plane for supporting a board to be edged, a first saw box disposed adjacent the reference plane and having at least two blades controllable for width, longitudinal angle and depth, a second saw box disposed adjacent the reference plane and having at least two blades controllable for width, longitudinal angle and depth, a saw controller coupled to the input for receiving signals from the scanner and coupled to the first and second saw boxes for setting the first saw box for cutting and controlling the cutting by the second saw box.

In accordance with another aspect of the present invention there is provided a board edger comprising a scanner for scanning a board to be edged to determine orientation and dimension, a reference plane for supporting a board to be edged, a first saw box disposed adjacent the reference plane and having at least two blades controllable for width, longitudinal angle and depth, a second saw box disposed adjacent the reference plane and having at least two blades controllable for width, longitudinal angle and depth, a saw controller coupled to the input for receiving signals from the scanner and coupled to the first and second saw boxes for setting the first saw box for cutting and controlling the cutting by the second saw box.

In accordance with a further aspect of the present invention there is provided a board edger comprising a reference plane for supporting a board to be edged, a first saw box disposed adjacent the reference plane and having at least two blades controllable for width, longitudinal angle and depth, a second saw box disposed adjacent the reference plane and having at least two blades controllable for width, longitudinal angle and depth, an input for coupling a saw controller, coupled a scanner for receiving signals therefrom, to the first and second saw boxes for setting the first saw box for cutting and controlling the cutting by the second saw box.

In accordance with a further aspect of the present invention there is provided A board edger comprising an infeed conveyor, a scanner for scanning a board to be edged as it passes on the infeed conveyor to determine orientation and dimension, a saw including a reference plane for supporting a board to be edged, a first saw box disposed adjacent the reference plane and having at least two blades controllable for width, longitudinal angle and depth, a second saw box disposed adjacent the reference plane and having at least two blades controllable for width, longitudinal angle and depth, and a saw controller coupled to the scanner for receiving signals from the scanner and coupled to the first and second saw boxes for setting the first saw box for cutting and controlling the cutting by the second saw box.

In an embodiment of the present invention the scanner may provide information concerning visual characteristics of the board.

Advantageously, while one saw box is cutting a board the other saw box is being set up by the saw controller to cut the next board. This is made possible by moving the other sawbox out of the infeed path as soon as it completed its cutting, thereby decreasing the spacing required between boards. This increases the throughout of the board edger.

### BRIEF DESCRIPTION OF THE DRAWINGS

The present invention will be further understood from the following detailed description with reference to the drawings in which:

FIG. 1 illustrates a known board edging system including a board edger;

FIG. 2 illustrates in a plan view a board edger in accordance with a first embodiment of the present invention;

FIG. 3 illustrates the board edger of FIG. 2 in a side elevation;

FIG. 4 illustrates a board edging system including a board edger of FIGS. 2 and 3;

FIG. 5 illustrates in a plan view a board edger in accordance with a second embodiment of the present invention;

FIG. 6 illustrates the board edger of FIG. 5 in a side elevation;

FIG. 7 illustrates, in a side elevation, a board edger in accordance with a third embodiment of the present invention;

FIG. 8 illustrates in a plan view, a board edger in accordance with a forth embodiment of the present invention.

### DETAILED DESCRIPTION OF THE PREFERRED EMBODIMENT

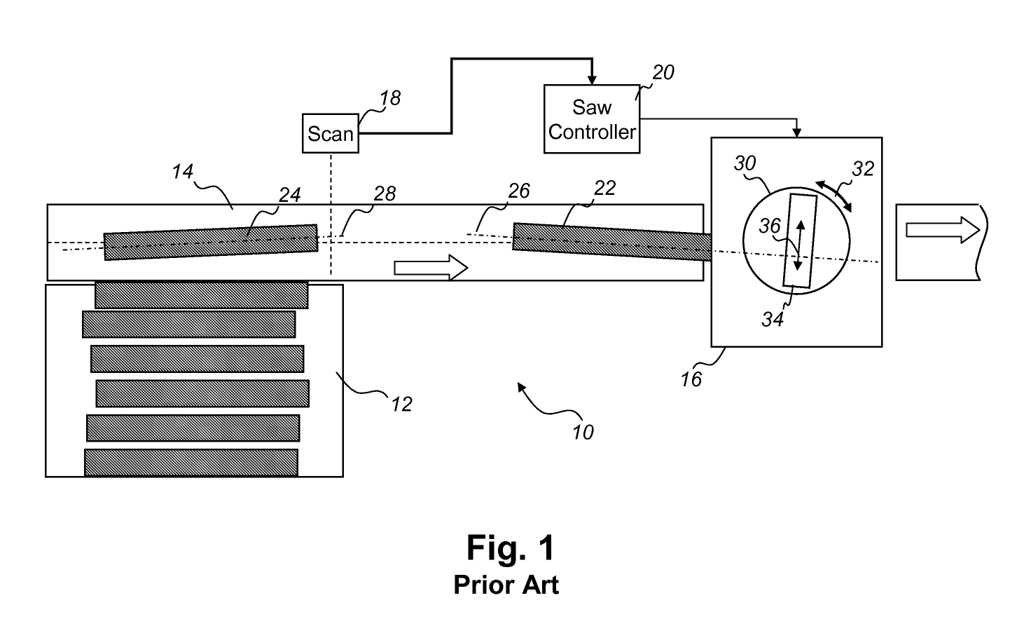

Referring to FIG. 1 there is illustrated a known board edger for a saw mill. The board edger system 10 includes a board table 12, and an infeed board conveyor 14 for feeding boards to a board edger 16. The board edger system also includes a scanner 18 and a saw controller 20. The scanner 18 scans each board 22 and 24 to determine their orientation 26 and 28, respectively, as well as what width of lumber can be saw from them. The scanner 18 feeds information to the saw controller 20. The board edger 16 includes a saw box 30 rotateable in direction 32 to align the saw blades with the axis of the approaching board, e.g. to align with axis 26. The boarder edger also includes a spindle 34 with the blades independently moveable along direction 36 to provide desired spacing and moving to track the orientation of the board being sawn.

In operation, the scanner 18 scans board 22, feeds the dimensional and orientation information to the saw controller 20. The saw controller then computes the angle of the saw box 30 rotating it in direction 32 to align the saw blades with the axis 26. The saw controller also sets the spacing between blades and causes the blades to move along direction 36 to provide to track the orientation of the board and to generate an optimal amount of lumber from the board.

While this type of board edger optimizes board utilization, the set-up time between cuts, necessitates a board spacing that limits saw throughput. Examples of this type of board edger are the applicant's U.S. Pat. No. 6,929,043, the entire specification of which is hereby incorporated by reference.

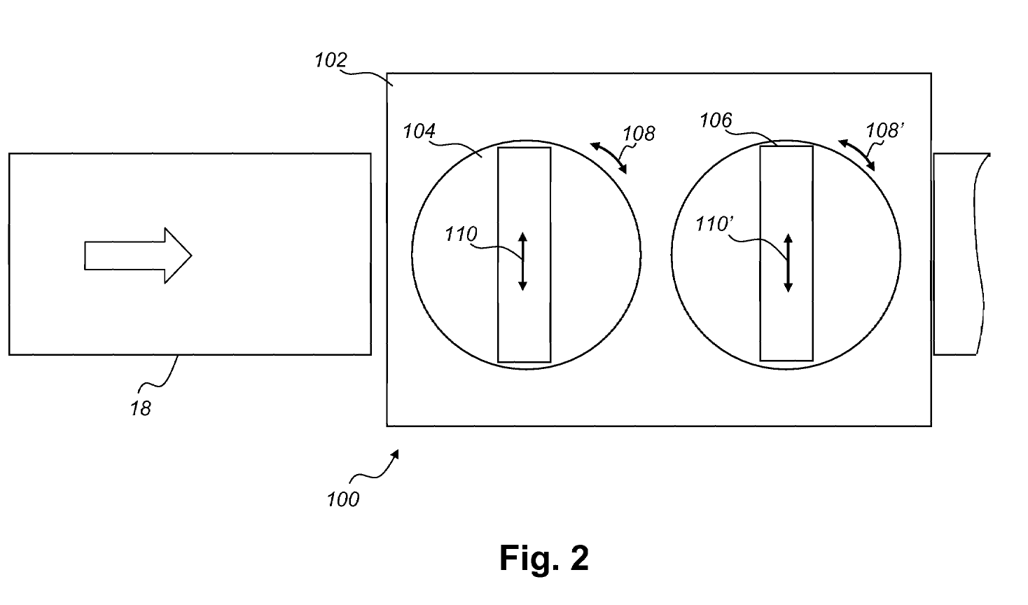

Referring to FIG. 2 there is illustrated, in a plan view, a board edger in accordance with a first embodiment of the present invention. The board edger 100 includes a saw 102 with twinned saw boxes 104 and 106, each independently rotatable in direction 108 to align the saw blades with the axis of the approaching board. Each saw box of the boarder edger 100 also includes a spindle with the blades independently moveable along direction 110 to provide desired spacing and moving to track the orientation of the board being sawn.

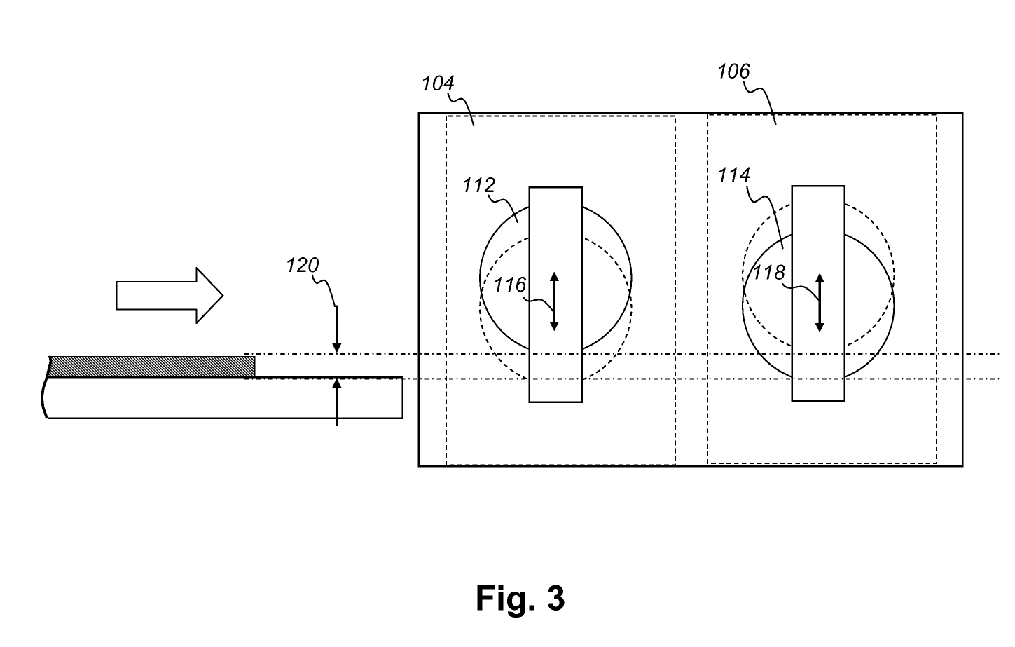

Referring to FIG. 3 there is illustrated the board edger of FIG. 2 in a side elevation. As shown in FIG. 3, each saw box 104 and 106 includes saw blades 112 and 114 mounted on an arbour movable in directions 116 and 118, respectively. a distance 120.

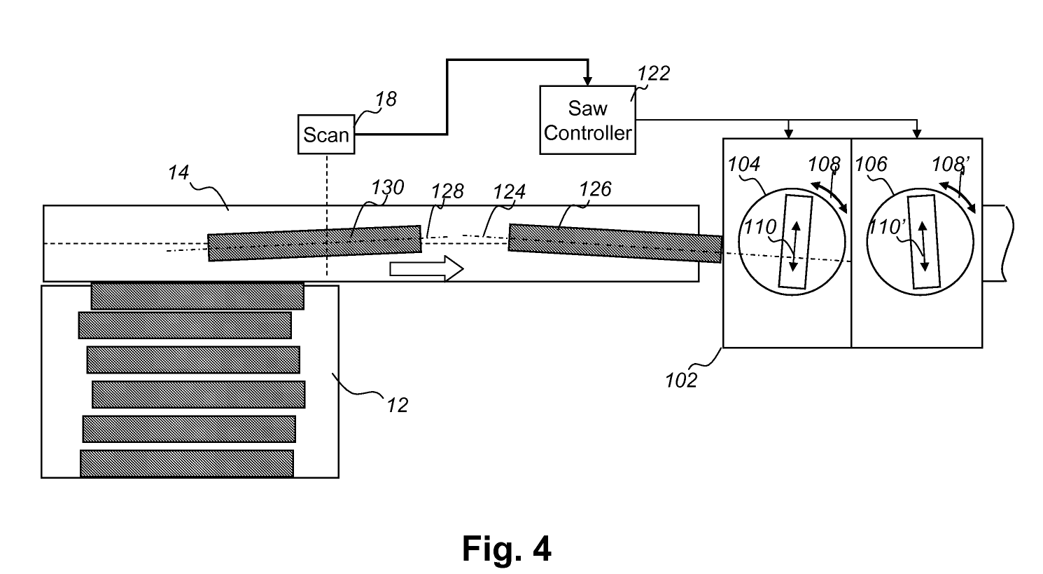

In operation, the boarder edger system of FIG. 4, the scanner 18 scans board 124, feeds the dimensional and orientation information to the saw controller 122. However in the case of the embodiment of FIGS. 2, 3 and 4, the saw controller 122 computes the angle of the saw box 104 rotating it in direction 108 to align the saw blades with the axis 124 of a first board 126. The saw controller also sets the spacing between blades and causes the blades to move along direction 110 to provide to track the orientation of the board and to generate an optimal amount of lumber from the first board.

Shortly thereafter, while the saw box 104 is cutting the first board, the saw controller 122 sets up the second saw box 106 for angle 108′ and spacing 110′ to align with the axis 128 of the second board 130. As shown in FIG. 3 the blades 112 and 114 alternate positions of cutting and not cutting by traversing the distant 120. This relatively short distance allows the saw controller to reduce the spacing between boards 126 and 130, thereby increasing throughput of the board edger system.

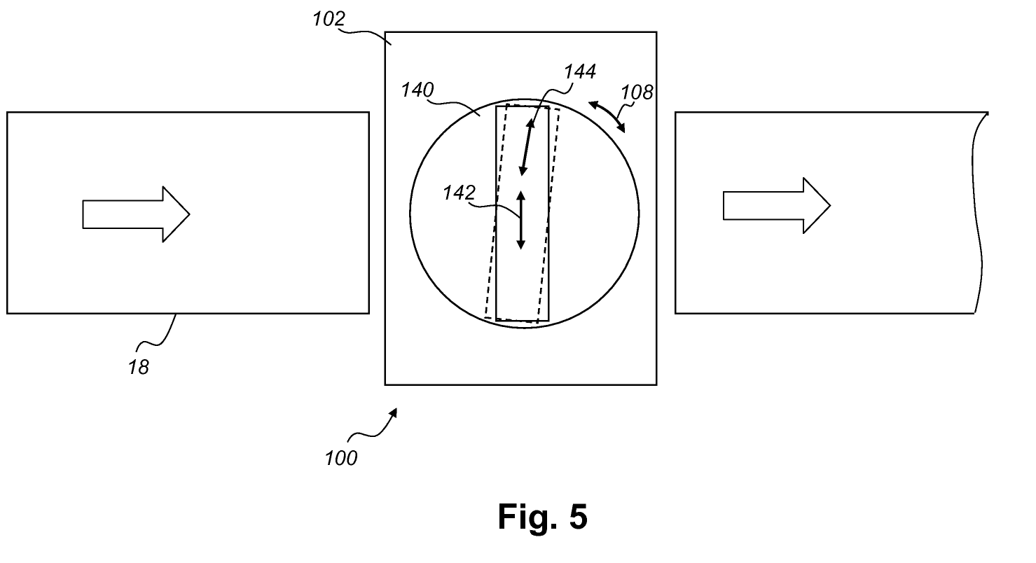

Referring to FIG. 5, there is illustrated in a plan view a board edger in accordance with a second embodiment of the present invention. In the second embodiment, the saw boxes 104 and 106 are stacked into one saw box 140. Each half separately rotatable in direction 108 as shown by direction arrows 142 and 144.

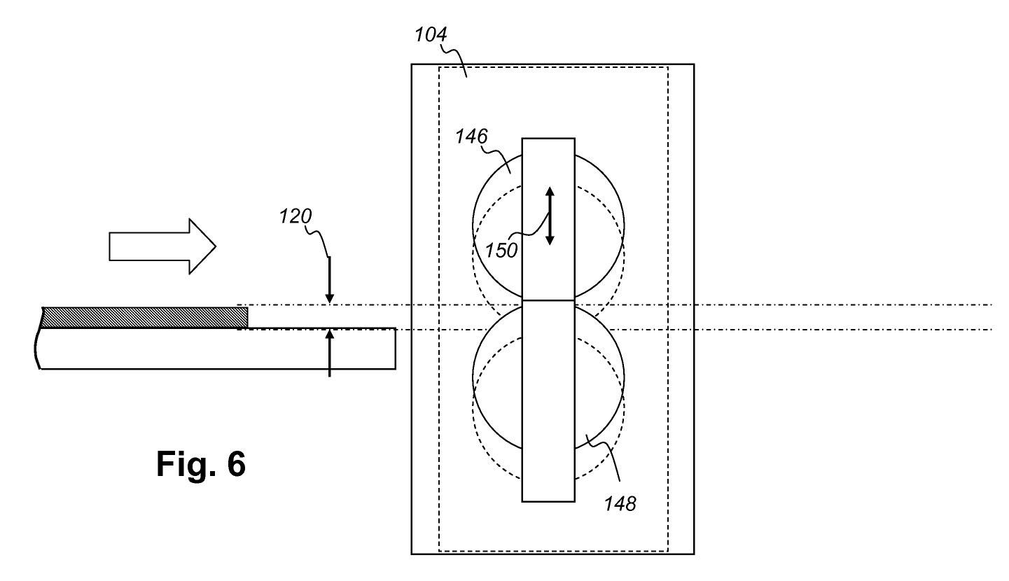

Referring to FIG. 6, there is illustrated the board edger of FIG. 5 in a side elevation. The saw arbours move blades 162 and 164 in the direction 166. As with the embodiment of FIGS. 2-4, one saw arbour is set up while the other one cuts.

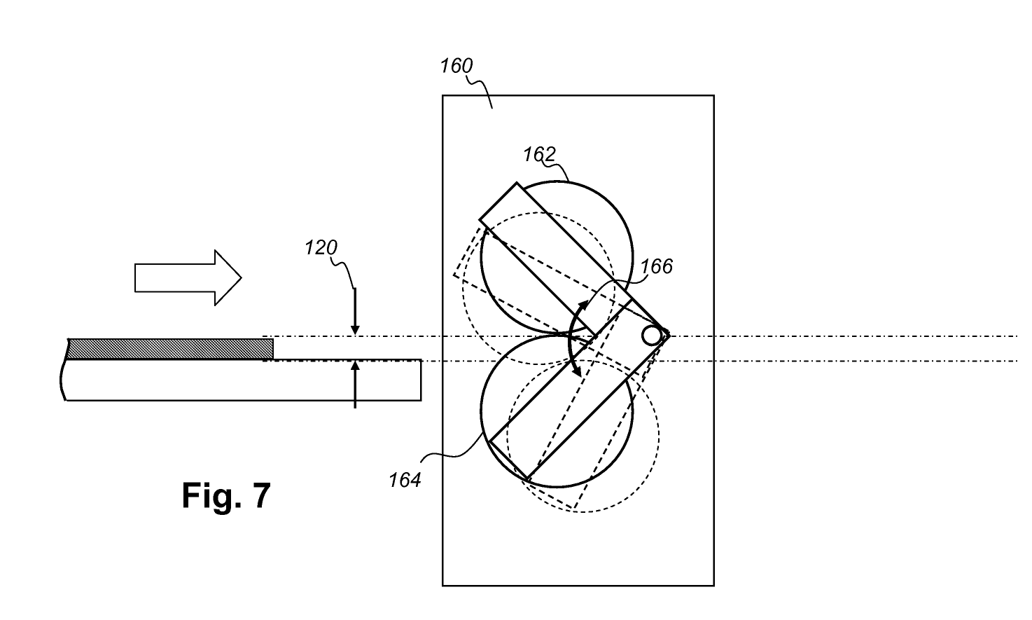

Referring to FIG. 7, there is illustrated, in a side elevation, a board edger in accordance with a third embodiment of the present invention. The board edger 160 mounts the saws 162 and 164 on an pivoted frame 166. Pivoting the frame provides the movement of the blades in and out of the cutting position through the distance 120.

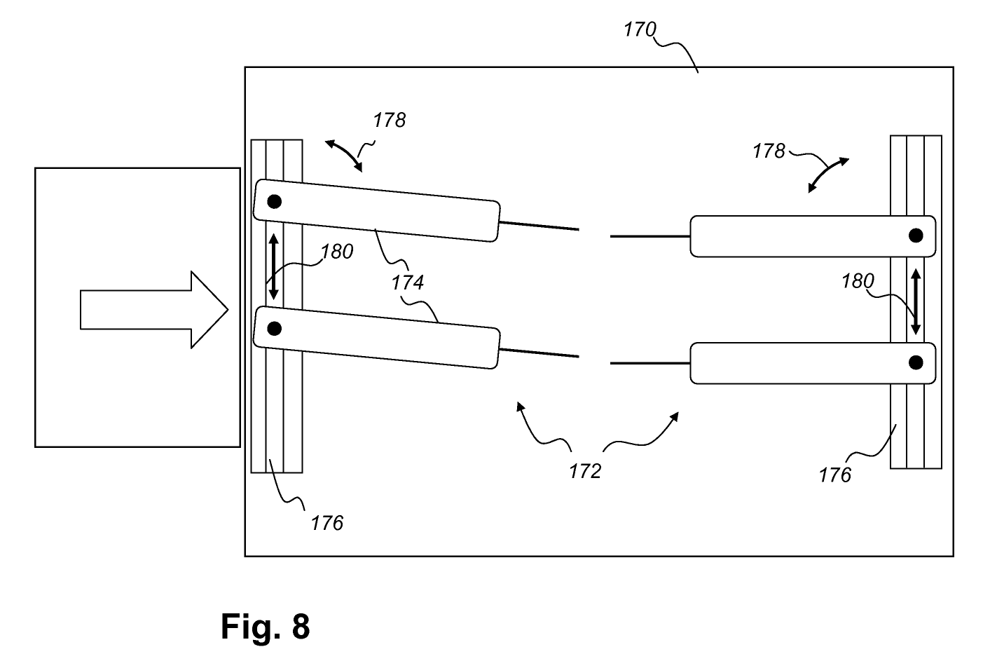

Referring to FIG. 8, there is illustrated, in a plan view, a board edger in accordance with a forth embodiment of the present invention. The board edger 170 includes saws 172, each comprising a pair of pivoted arms 174 with a powered saw blade and mounted on slides 176 that allow independent or synchronous transverse movement for adjusting lumber width and tracking board position, respectively. The slides also provide the movement of the blades in and out of the cutting position through the distance 120. The saws 172 are shown in an opposing configuration in FIG. 8, however they could both be set up in either a leading arm or trailing arm configuration. It would also be possible to use this type of saw in the embodiments of FIGS. 5 and 6 with one set of saw above the other set.

The embodiment of FIG. 7 could also be implemented either using saws 172 of FIG. 8, with both slides 176 mounted on the pivot frame or the blade angling technique taught in U.S. Pat. No. 5,884,682 issued in Mar. 23, 1999.

For the various embodiments taught herein above, it is also contemplated that different saw blade sizes may be used and that the machine geometry may be adjusted to accommodate these different saw blade sizes and consequently, if of smaller diameter and more closely spaced, they would further reduce the saw set-up time.

Numerous modifications, variations and adaptations may be made to the particular embodiments described above without departing from the scope patent disclosure, which is defined in the claims.

What is claimed is:

1. A board edger comprising:
an input for receiving a signal from a scanner;
a reference plane for supporting a board to be edged;
a first saw box disposed adjacent the reference plane and having at least two blades controllable for width, longitudinal angle and depth;
a second saw box disposed adjacent the reference plane and having at least two blades controllable for width, longitudinal angle and depth;
a saw controller coupled to the input for receiving signals from the scanner and coupled to the first and second saw boxes for setting the first saw box for cutting and controlling the cutting by the second saw box.

2. A board edger as claimed in claim 1, wherein the second saw box is longitudinally displaced from the first saw box.

3. A board edger as claimed in claim 2, wherein first and second saw boxes are both disposed on a same side of the reference plane.

4. A board edger as claimed in claim 2, wherein first and second saw boxes are both disposed on opposite sides of the reference plane.

5. A board edger as claimed in claim 1, wherein the second saw box opposes the first saw box.

6. A board edger as claimed in claim 5, wherein first and second saw boxes are both disposed on opposite sides of the reference plane.

7. A board edger as claimed in claim 1, wherein the first saw box and the second saw box are pivotally mounted for movement between a first and a second position for alternately engaging a board to be sawn.

8. A board edger as claimed in claim 7, wherein first and second saw boxes are both disposed on a same side of the reference plane.

9. A board edger as claimed in claim 7, wherein first and second saw boxes are both disposed on opposite sides of the reference plane.

10. A board edger comprising:
a scanner for scanning a board to be edged to determine orientation and dimension;
a reference plane for supporting a board to be edged;
a first saw box disposed adjacent the reference plane and having at least two blades controllable for width, longitudinal angle and depth;
a second saw box disposed adjacent the reference plane and having at least two blades controllable for width, longitudinal angle and depth;
a saw controller coupled to the input for receiving signals from the scanner and coupled to the first and second saw boxes for setting the first saw box for cutting and controlling the cutting by the second saw box.

11. A board edger comprising:
a reference plane for supporting a board to be edged;
a first saw box disposed adjacent the reference plane and having at least two blades controllable for width, longitudinal angle and depth;
a second saw box disposed adjacent the reference plane and having at least two blades controllable for width, longitudinal angle and depth;
an input for coupling a saw controller, coupled a scanner for receiving signals therefrom, to the first and second saw boxes for setting the first saw box for cutting and controlling the cutting by the second saw box.

12. A board edger as claimed in claim 11, wherein the second saw box is longitudinally displaced from the first saw box.

13. A board edger as claimed in claim 12, wherein first and second saw boxes are both disposed on a same side of the reference plane.

14. A board edger as claimed in claim 12, wherein first and second saw boxes are both disposed on opposite sides of the reference plane.

15. A board edger as claimed in claim 11, wherein the second saw box opposes the first saw box.

16. A board edger as claimed in claim 15, wherein first and second saw boxes are both disposed on opposite sides of the reference plane.

17. A board edger as claimed in claim 11, wherein the first saw box and the second saw box are pivotally mounted for movement between a first and a second position for alternately engaging a board to be sawn.

18. A board edger as claimed in claim 17, wherein first and second saw boxes are both disposed on a same side of the reference plane.

19. A board edger as claimed in claim 17, wherein first and second saw boxes are both disposed on opposite sides of the reference plane.

20. A board edger comprising:
an infeed conveyor;
a scanner for scanning a board to be edged as it passes on the infeed conveyor to determine orientation and dimension;
a saw including a reference plane for supporting a board to be edged, a first saw box disposed adjacent the reference plane and having at least two blades controllable for width, longitudinal angle and depth, a second saw box disposed adjacent the reference plane and having at least two blades controllable for width, longitudinal angle and depth; and
a saw controller coupled to the scanner for receiving signals from the scanner and coupled to the first and second saw boxes for setting the first saw box for cutting and controlling the cutting by the second saw box.
